(19) United States
(12) Patent Application Publication
(10) Pub. No.: US 2020/0125660 A1
(43) Pub. Date: Apr. 23, 2020

(54) QUICK IDENTIFICATION AND RETRIEVAL OF CHANGED DATA ROWS IN A DATA TABLE OF A DATABASE

(71) Applicant: CA, Inc., Islandia, NY (US)

(72) Inventor: Kevin P. Shuma, Celina, TX (US)

(73) Assignee: CA, Inc., Islandia, NY (US)

(21) Appl. No.: 16/166,060

(22) Filed: Oct. 19, 2018

(51) Int. Cl. G06F 17/30

(52) U.S. Cl. CPC G06F 17/30371; G06F 17/30477; G06F 17/30377; G06F 17/30368

(57) ABSTRACT

An embodiment includes detecting a request for a change related to a first data row of a first table in a first database, identifying a unique record identifier of the first data row, and performing a first search of a change index for an index entry corresponding to the first data row. The first search is based on the unique record identifier and each index entry includes a date and time indicating a last change related to a corresponding data row. The embodiment further includes updating the index entry corresponding to the first data row with a first date and time indicating the change related to the first data row and identifying data rows that are changed subsequent to a prior date and time by performing a second search of the change index for index entries containing a date and time that is greater than the prior date and time.

### BACKGROUND

The present disclosure relates in general to the field of data storage, and more specifically, to quick identification and retrieval of changed data rows in a data table of a database.

A database is a data structure used to store data as an organized collection of information. The typical construct of data in an organized collection is as a set of data rows. Databases may utilize mass storage devices (MSDs) to store large quantities of data and to enable continuous or near-continuous access to the data. Retailers, government agencies and services, educational institutions, transportation services, and health care organizations are a few of the entities that are known to maintain database systems containing a large amount of data rows. Entities with such database systems often provide, ‘always on’ access to their data by customers, employees, students, or other authorized users. Continuous changes to the data may be allowed to occur with online user transactions or other access to the data such as batch updates or utility processes.

Recently, many entities that maintain or control legacy databases have been moving copies of the legacy data rows to big data environments for ongoing analysis. As the amount of data transferred grows and the requirement for timeliness of the data increases, Information Technology (IT) professionals, such as database administrators (DBAs), may see increased complexity and overhead on the legacy systems to keep the data rows in the big data environment current. The complexity and overhead may limit the amount of data transferred to big data or the timeliness of the data. This need to copy changed data rows is also seen in other areas, for example, where there is a need to move data rows from one system to another.

### BRIEF SUMMARY

According to one aspect of the present disclosure, a request for a change related to a first data row of a first table in a first database is detected. A unique record identifier of the first data row is identified. A first search of a change index for an index entry corresponding to the first data row is performed. The first search may be based on the unique record identifier. In the change index, each index entry includes a data and time indicating a last change related to a corresponding data row. The index entry corresponding to the first data row is updated with a first date and time indicating the change related to the first data row. Data rows that are changed subsequent to a particular date and time are identified by performing a second search of the change index for index entries containing a date and time that is greater than the particular date and time.

### BRIEF DESCRIPTION OF THE DRAWINGS

FIG. 1 is a simplified block diagram of an example of some components of a communication system for quick identification and retrieval of changed data rows in a data table of a database, according to at least one embodiment of the present disclosure.

FIG. 2 is a simplified block diagram illustrating additional details of certain components of the communication system according to at least one embodiment.

FIG. 3 is a simplified block diagram illustrating additional details of a database that may be provided in the communication system according to at least one embodiment.

FIG. 4 is a simplified block diagram illustrating additional details of another database that may be provided in the communication system according to at least one embodiment.

FIG. 5 is a simplified block diagram illustrating an example format of an index entry that may be used in the communication system according to at least one embodiment.

FIG. 6 is a simplified block diagram illustrating example data and operation flow of the communication system according to at least one embodiment.

FIG. 7 is a simplified flowchart of possible operations related to monitoring changes in a database of the communication system according to at least one embodiment.

FIG. 8 is a simplified flowchart of other possible operations related to monitoring changes in a database of the communication system according to at least one embodiment.

FIG. 9 is a simplified flowchart of possible operations related to querying changes in a database of the communication system according to at least one embodiment.

FIG. 10 is a simplified flowchart of possible operations related to updating a target database of the communication system according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” “element,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but is not limited to, an electronic, magnetic, optical, electromagnetic, or semiconductor system, apparatus, or device, or any suitable combination of the foregoing. More specific examples (a non-exhaustive list) of the computer readable storage medium include the following: a mass storage device (MSD), a Universal Serial Bus (USB) flash drive, a portable computer diskette, a hard disk, a random access memory (RAM), a read-only memory (ROM), a programmable read-only memory (PROM), an erasable programmable read-only memory (EPROM or Flash memory), an electrically erasable read only memory (EEPROM), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, low-level programming languages such as assembly languages, conventional procedural programming languages, such as the “C” programming language, Visual Basic, Fortran 2003, Perl, COBOL 2002, PHP, ABAP, assembly language, dynamic or script programming languages such as Python, Ruby and Groovy, batch file (.BAT or .CMD), powershell file, REXX, or any format of data that can describe sequences (e.g., XML, JSON, YAML, etc.), or other programming languages. By way of example, the program code may execute entirely on a mainframe system, entirely on a database server, partly on a mainframe system or database server and partly on a remote computer, or entirely on a remote computer. In the scenarios involving a remote computer, the remote computer (e.g., server) may be connected to a mainframe system and/or database server through any type of network, including a local area network (LAN) or a wide area network (WAN), or the connection may be made through an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses, or other devices to produce a computer implemented process such that the instructions, which execute on the computer, other programmable apparatuses, or other devices, provide processes for implementing the functions/acts specified in the flowchart and/or block diagram block or blocks.

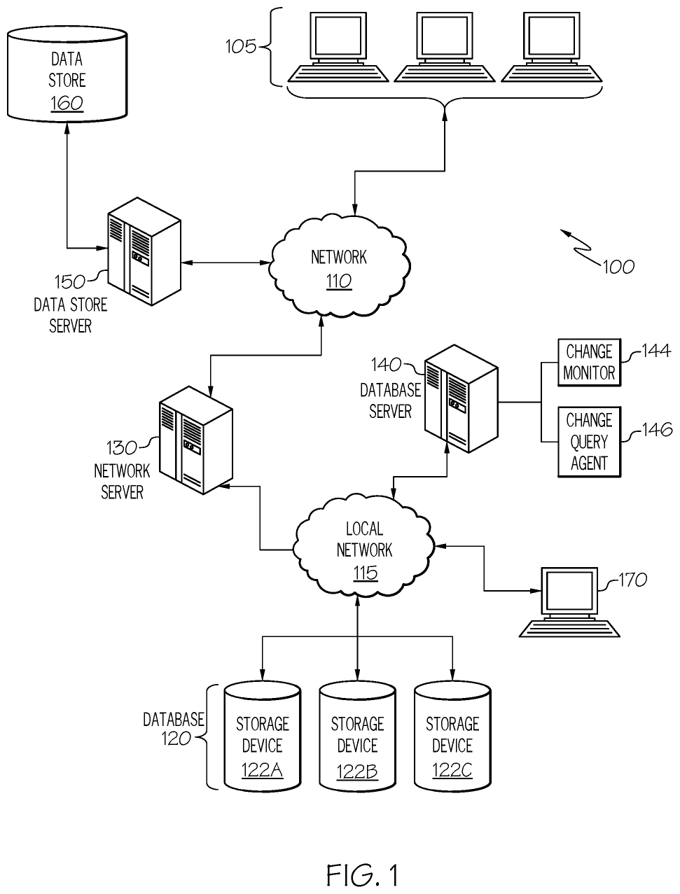

Referring now to FIG. 1, a simplified block diagram is shown illustrating an example communication system 100 for quick identification and retrieval of changed data rows in a data table of a database according to at least one embodiment. In communication system 100, a network 110 (e.g., a wide area network such as the Internet) facilitates communication between a data store server 150 and a network server 130, to enable data to be stored, accessed, and/or managed in data store 160. In one example, data store server 150 and data store 160 represent a big data environment. Network 110 also facilitates communication between user devices 105 and network server 130. Network server 130 may be configured to communicate with one or more of a database server 140, a database 120, and a user terminal 170. In one implementation, such communication may be provided via a local network 115. Network server 130 may be configured to enable access from user devices 105 to database server 140 and database 120, which can include one or more data storage devices, such as data storage devices 122A, 122B, and 122C. User devices 105 can enable users to interface with database server 140 and to consume data contained in database 120. User terminal 170 may be used to enable an authorized user, such as a Database Administrator (DBA), to communicate with and issue commands to database server 140 to access and/or manage the database. In other embodiments, user terminal 170 could be directly connected to database server 140 or could be remotely connected to database server 140 over the Internet, for example.

Database server 140 may include a change monitor 144 to monitor changes made to data in the database and a change query 146 to perform queries to identify and retrieve changes to data rows in the database based on change dates or change dates and change times. Also, although storage devices 122A-122C are shown as separate storage devices communicating with database server 140 via local network 115, it should be apparent that one or more of these storage devices may be combined in any suitable arrangement and that any of the storages devices 122A-122C may be connected to database server 140 directly or via some other network (e.g., wide area network, direct connection, etc.). Moreover, one or more of the components shown in FIG. 1 may be provided in a mainframe system in at least some implementations.

For purposes of illustrating certain example techniques of communication system 100 for quick identification and retrieval of changed data rows in a data table of a database (e.g., 120), it is important to understand the activities that may be occurring in a network environment that includes a database capable of hosting large quantities of data. The following foundational information may be viewed as a basis from which the present disclosure may be properly explained.

A database generally refers to a data structure for storing an organized collection of data that can be easily accessed, managed, and updated. Databased may be used to store large quantities of data. Many databases are provisioned on mass storage devices (e.g., MSDs, DASDs), which are used to store massive amounts of data across virtually every sector of society including, but not limited to, social media, business, retail, health, education, and government. Although the concepts presented herein are applicable to any type of data structure used in storage devices, most of the world's data is stored in data structures of a database. Therefore, the discussion herein may reference databases for ease of illustration; however, it should be understood that the concepts are applicable more generally and, as used herein, the term ‘database’ is intended to refer to any type of data structure used for storing an organized collection of data.

A typical database may include multiple objects. As used herein, an ‘object’ is intended to include any data structure (or format) for organizing, managing, and storing data to enable access and modification of the data. Examples of objects include, but are not necessarily limited to tables, indexes, tablespaces, and index spaces. A tablespace can be embodied as a file containing raw data, some of which can be application data and some of which can be used internally to help manage the data. Logical data columns can be arranged in logical data rows within a tablespace. These logical data columns are stored as a logical data table. In some implementations, a logical data table (also referred to herein as ‘table’) may be viewable and potentially modifiable by a user.

Like a tablespace, an index space can also be embodied as a file containing raw data. An index space, however, may be defined for a particular data table. Moreover, in at least one implementation, an index space may contain a single index for a single data table. One or more selected logical data columns from the data table may be arranged in a desired order in logical data rows within an index space. These logical data columns within the index space may be stored as a logical index (also referred to herein as ‘index’) and contain the data from those columns in the data table. The index can also include pointers to rows in the data table. Various different types of indexes may be created. For example, a unique index may ensure that the value in a particular column or set of columns is unique, a primary index may be a unique index on the primary key of the table, a secondary index may be an index that is not the primary index, a clustering index may ensure a logical grouping, and an expression-based index may be based on a general expression. Other index types may be applicable to particular types of tables (e.g., partitioned tables, XML tables, etc.).

Databases are used by a multitude of entities to store information related to their specific activities. Depending on the entity, such activities may be related to business, government, education, healthcare, banking and finance, transportation, or any other service, scheme, or enterprise that engages in information gathering or collection. Databases are common in large mainframe systems as well as smaller distributed and midrange systems. Some databases can hold massive amounts of information. For example, sales transactions, product catalogs and inventories, customer profiles, patient records, and the like may result in the aggregation of millions of data rows in databases storing such information.

With the advent of big data environments offering seemingly unlimited data storage and services, entities with existing databases have been increasingly tapping the data storage and services offered by these environments. For example, an entity may copy its legacy data to a big data store in the cloud to obtain on-going data analysis services. As the legacy database continues to be changed (often continuously with ‘always on’ access), the changes to the data need to be propagated to the corresponding data in the cloud data store. Otherwise, the analysis and other services may be rendered meaningless.

Replication of data from a source environment to modern platforms is typically performed by copying data rows from the source environment to a target environment. To update a target data store (e.g., data store 160), for example, data moving services typically need the data rows in the source that have changed since the last time the target data store was updated. The images of the changed data rows are then added to the target data store. For example, if a database file contains 10,000 data rows, but only 100 data rows have been changed since the last update to the target data store, only the 100 changed data rows in the database need to be moved to the target data store. Nevertheless, users often perform these updates by moving the entire database file (e.g., all 10,000 data rows) because there is no simple technique for identifying changed data rows.

Existing options for identifying changed data rows in databases of modern mainframe systems, however, are largely inadequate. Although current change capture mechanisms may provide granularity of data column and row changes, obtaining the needed information (e.g., changed data rows since the last update) may be complex and resource intensive. For example, some databases are configured to generate log streams that record every change made to the database to enable recovery if needed. Using the log stream data to create a list of changed rows would require complex log stream processing capabilities. The format of a log record is generally designed to enable recovery of the database, rather that user-readable data rows. In addition, log records may not necessarily keep the entire record, but rather, just the parts that have changed. Therefore, processing a log stream requires specific knowledge of the log record format, which may not be consistent across databases.

Change capture processing of the log records could add significant overhead to the system. A typical change capture process may take a log record (of partial changes) and reconstruct a before and after picture of each record. The log records must be processed in the order of recorded changes to obtain accurate results of the changed data rows. By way of example, if 10 days of log stream records are processed, each day must be processed in the correct chronological order and each record within each day must be processed in the correct chronological order. In some cases, a specific data row may be changed multiple times within the span of ten days and therefore would have multiple log stream records that would need to be processed. Thus, there is potential for a significant amount of processing and resource utilization. Additionally, to the extent that a log stream typically contains all changes to all databases in a database server, some databases may contain sensitive, proprietary or otherwise confidential information, and log stream processing can create additional security risks for exposure and leakage of the sensitive, proprietary, or otherwise confidential information. Moreover, some databases are not implemented with a log stream and other databases may not have a log stream that is available in real-time.

A separate or add-on change capture facility or engine may provide real-time information but can be complex to set-up and expensive to maintain. In addition to a log stream, a change capture facility captures every change and stores it to a separate table of changes. If a data row changes 50 times, for example, the 50 changes are recorded in the table of changes even if the changes are made to the same data. Processing the table of changes would be similar to processing the log stream. Such processing would be complex and could incur significant overhead. Additionally, security concerns related to confidential information would also not be remedied.

Modifying the internal structure of a database to accommodate dates and times for each row is also not feasible. Such an approach would necessitate modifications to table row definitions. In addition, all applications that access the data table would have to be modified to update the date and time column each time a data row was changed. Modifying applications in database systems typically requires significant research and human resources, which can be expensive. Also, additional procedures and processes may be required to track deleted data rows. Furthermore, as systems increase in size and age, the human error factor increases. In addition, this approach may be susceptible to a malicious actor who intentionally prevents the application modifications from taking effect. The malicious actor could then use the application to make changes to data that would go undetected.

As illustrated, potential options to identify changed data rows for performing time-based updates generally require defining additional resources, creating new processes, and/or continuously monitoring and managing the mechanisms used. Thus, more effective techniques are needed by database administrators and data owners to track changes to a database by data row based on the change dates and change times.

A communication system, such as communication system 100 for quick identification and retrieval of changed data rows in a data table of a database, as outlined in the FIGURES, can overcome these issues and others. This system can leverage existing database services to enable the selective creation of an internal index (also referred to herein as ‘change index’) that tracks the date, and optionally the time, of changes made to each data row in a data table. The tracked changes can include data row deletions as well as data row additions and modifications. The change index maps each row to the date and time of the last change made to the row. The change index may also map each row to the type of change (e.g., add, modify, or delete) that was last made to the row.

In at least one embodiment, a respective change index may be created for each data table. In one embodiment, a change index for a particular data table may be built incrementally by creating an index entry in the change index for each data row that experiences a change (e.g., added, deleted, modified) and that does not already have a corresponding index entry in the change index. Thus, the change index is populated with an index entry for every data row that experiences some type of change. In at least one embodiment, each index entry contains a unique row identifier of a single data row, the last date (and optionally time) that the data row was changed, and an indication of the type of change that was last made to the data row. In some embodiments an existing row identifier structure offered by a database may be leveraged to map index entries to their corresponding data rows. As subsequent updates (e.g., addition, deletion, modification) are made to the data table, the appropriate index entries can be updated with the date and time of the change and an indication of the type of change made. Thus, queries may be performed on the change index using data and time parameters to extract data rows that were updated after a particular date and time.

Embodiments disclosed herein can provide a simple and low-overhead technique to identify and retrieve data rows from a source environment (e.g., a legacy database) that need to be replaced in a target environment (e.g., a big data store). A change index used in the embodiments described herein can be built on the fly, without data interruption to a database. This is particularly desirable for ‘always on’ databases. In addition, the change index may use a single entry for each data row and thus, does not require a significant amount of additional index space. Rather, the space requirements are relatively small and can be dynamically added when a DBA (or other authorized user) selects an option to activate change tracking for a data table. The ability to track changes in a database using one or more change indexes can be implemented on a table by table basis without changing the actual data rows of a data table or any applications that update the data table. Furthermore, using the change index to identify updates to the database that occurred after a specified prior date (and possibly time), can be done with any desired frequency (e.g., every minute, every hour, every day, every few days, every week, etc.).

Embodiments herein also enable data tables in a database to be copied in full to a target environment while the database is in-use. Upon successfully copying the data tables, a change query can be executed to identify and retrieve any changes that occurred in the data table after the start of the data table copy to the target environment. Thus, any changes that were made to the data table while the data table copy process was running could be propagated to the target environment. Thus, the copied data table in the target environment can be synchronized with the data table in the source database. Subsequent change queries to identify and retrieve of changed data rows could look for rows that were changed subsequent to the last change query.

Turning to FIG. 1, a brief description of the infrastructure of communication system 100 is now provided. Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs.

Generally, communication system 100 can be implemented in any type or topology of networks. Within the context of the disclosure, networks such as networks 110 and 115 represent a series of points or nodes of interconnected communication paths for receiving and transmitting packets of information that propagate through communication system 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Networks 110 and 115 can use any suitable technologies for communication including wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth, NFC, etc.). Suitable interfaces and infrastructure may be provided to enable communication within the networks.

In general, “servers,” “clients,” “computing devices,” “storage devices,” “network elements,” “database systems,” “data repositories,” “network servers,” “user devices,” “user terminals,” “systems,” etc. (e.g., 105, 120, 130, 140, 150, 160, 170, etc.) in example communication system 100, can include electronic computing devices operable to receive, transmit, process, store, or manage data and information associated with communication system 100. As used in this document, the term “computer,” “processor,” “processor device,” or “processing device,” is intended to encompass any suitable processing device. For example, elements shown as single devices within communication system 100 may be implemented using a plurality of computing devices and processors, such as server pools including multiple server computers. In some embodiments, one or more of the elements shown in FIG. 1 may be combined to form a mainframe system. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, storage devices, network elements, database systems, network servers, user devices, user terminals, systems, etc. (e.g., 105, 120, 130, 140, 150, 160, 170, etc.) can each include one or more processors, computer-readable memory, and one or more interfaces, among other features and hardware. Servers can include any suitable software component, manager, controller, or module, or computing device(s) capable of hosting and/or serving software applications and/or services, including distributed, enterprise, or cloud-based software applications, data, and services. For instance, in some implementations, database server 140, data store server 150, data store 160, storage devices 122A-122C of database 120, and network server 130, or other sub-system of communication system 100, can be at least partially (or wholly) cloud-implemented, web-based, or distributed to remotely host, serve, or otherwise manage data, software services and applications interfacing, coordinating with, dependent on, or used by other services, devices, and users (e.g., via user devices, network user terminals, other user terminals, etc.) in communication system 100. In some instances, a server, system, subsystem, or computing device can be implemented as some combination of devices that can be hosted on a common mainframe system, computing system, server, server pool, or cloud computing environment and share computing resources, including shared memory, processors, and interfaces.

While FIG. 1 is described as containing or being associated with a plurality of elements, not all elements illustrated within communication system 100 of FIG. 1 may be utilized in each alternative implementation of the present disclosure. Additionally, one or more of the elements described in connection with the examples of FIG. 1 may be located external to communication system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

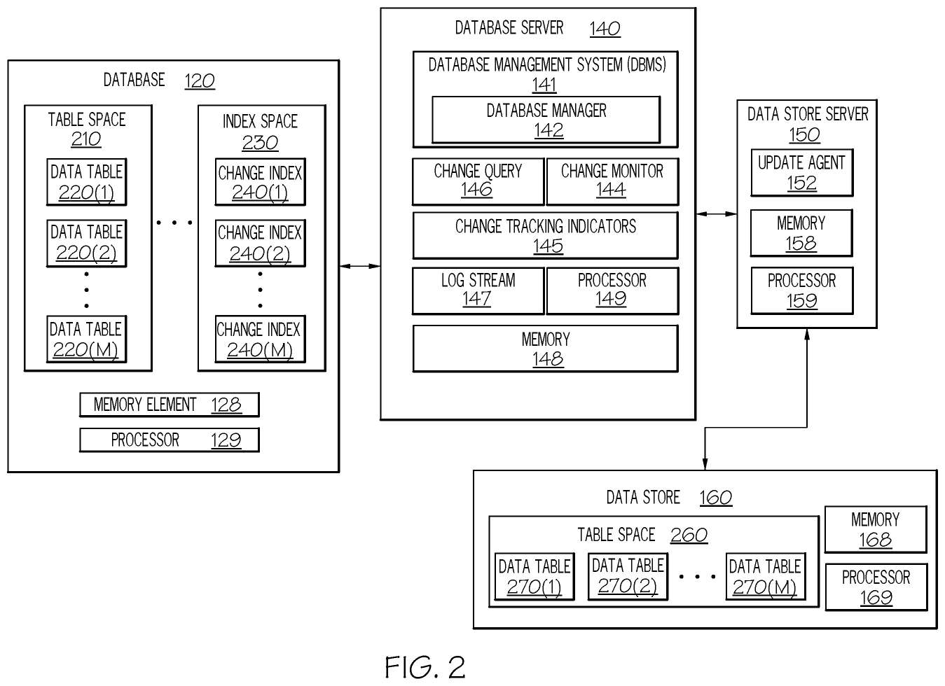

FIG. 2 is a simplified block diagram that illustrates additional possible details that may be associated with certain components of communication system 100. Specifically, in accordance with at least one embodiment, possible details of database server 140, database 120, and data store 160 are illustrated in FIG. 2.

Database 120 may include a tablespace 210 and an index space 230. Tablespace may include one or more data tables 220(1)-220(M). The number of data tables included in a single tablespace, such as tablespace 210, may vary at least in part based on the type of tablespace that is configured. Index space 230 may include one or more change indexes 240(1)-240(M). In this example, each change index can be associated with a single data table. In some embodiments, each index space contains one change index for multiple data tables. It should be noted that FIG. 2 is a simplified block diagram for illustrative purposes, and that a database, such as database 120, may include any number of tablespaces and change indexes, and potentially other indexes and types of tables (e.g., catalog tables). Database 120 may also include appropriate hardware, including, but not necessarily limited to a memory 128 and a processor 129.

A change index (e.g., 240(1)) may be created for a particular data table (e.g., 220(1)) and may include multiple entries. Once the change index is created, each time a data row is changed, an entry is created in the change index. The entry can include a unique row identifier (which may internal to the system), a date and time of the last change made to the data row, and a type of the change (e.g. add, modify, delete). If an entry already exists in the change index, then it may be updated to indicate the time of the change and the type of the change. If the row is changed multiple times, the entry is updated each time with the new date and time and the type of change. At any given time, the entry contains the date and time and the type of change of the last change (e.g., add, delete, or modify) made to the data row. Added rows have an entry created in the change index when they are added, deleted rows have an entry created or updated in the change index when they are deleted. For deleted rows, the entry remains in the change index until it is processed by a downstream process.

Each entry may correspond to a respective data row in the data table. The change index may or may not contain entries for every data row in the data table. In at least one embodiment, if a data row exists in the data table before the change index is created, and if the data row is never updated, then the change index may not include an entry corresponding to that data row.

In at least one embodiment, a change index may not be created until change tracking for the data table is activated by a user. In this embodiment, a user may select one or more data tables for change tracking. A change index may be created for each of the selected one or more data tables. In addition, the data table may be marked in the database (e.g., change tracking indicators 145) to indicate that change tracking has been activated for that data table.

In communication system 100, data store 160 illustrates an example of a remote database in which a copy of database 120 is stored. In at least one implementation, data store 160 may be provisioned in a big data environment in a cloud with data store server 150, which may be accessible by database server 140 via a wide area network such as the Internet. This implementation may be desirable in at least some scenarios to gain access to services provided by the big data environment, such as on-going analysis of data. Although this is one possible implementation, the concepts presented herein are not limited to this configuration. In fact, a data store may be provisioned in a local area network with database server 140 or any other network to which database server 140 has access.

In this example, data store server 150 includes an update agent 152 and any appropriate hardware such as memory 158 and processor 159. Update agent 152 can include logic to apply data row changes that may be received from database server 140 to data store 160.

In this example, data store 160 can include a tablespace 260 with data tables 270(1)-270(M). Data store 160 may also include other objects including, for example, other tablespaces, index spaces, catalogs, etc. In this example, tablespace 260 contains a copy of the data contained in tablespace 210 of database 120. Accordingly, the same number of data tables are defined in each tablespace. In other scenarios, one or more selected data tables may be contained in data store 160. In yet another scenario, if multiple tablespaces are contained in database 120, then one or more of those multiple tablespaces may be contained in data store 160. Generally, any object (e.g., tablespace, data table, etc.) that is contained in database 120, and for which a change index can be created, may be replicated in data store 160. Data store 160 may also include appropriate hardware, including, but not necessarily limited to a memory 168 and a processor 169.

Database server 140 may include a database management system (DBMS) 141, which creates and manages databases, including providing data utilities (e.g., batch utilities), tools, and programs. A database manager 142 can create a database processing region where user processing and most utility processes flow. In at least one embodiment, database manager 142 may be configured to enable a user (e.g., DBA or other authorized user) to select an option to activate change tracking for a particular data table or multiple data tables. When change tracking is activated for a particular table, a change index can be dynamically created for that data table. When change tracking is activated for multiple data tables, a respective change index can be dynamically created for each of the multiple data tables. Database server 140 may also include change tracking indicators 145, which can be used to indicate whether change tracking has been activated for a particular data table. Accordingly, if change tracking is activated for a particular data table, then a change tracking indicator mapped to that particular data table may be set (e.g. a bit set to “1”).

A change monitor 144 may be provisioned to run in DBMS 141 to monitor changes made to data rows in data tables for which a change index has been created, and to update the appropriate change index when an updated to a data row is detected. In one example, updates may include deletions, additions, and modifications. Change monitor 144 can be designed to populate a new change index incrementally. That is, once a change index is created for a data table, each time a data row in the data table is updated (e.g., deleted, added, modified) and that update is detected by change monitor 144, change monitor 144 may create an index entry in the change index and store appropriate information related to the data row in the entry. The information can include a unique row identifier that uniquely identifies the data row that has been updated, a date and time of the update to the data row, and an indication of the type of update that occurred (e.g., deletion, addition, or modification).

A change query 146 may also be configured to run in DBMS 141. Change query 146 may be run at any desired interval or on demand. In some implementations, change query 146 may comprise multiple queries to perform the identification and retrieval operations of data rows that are associated with a change index. The parameters of a change query may include a data table identifier such as its name, and a date that indicates the date after which changes in the data table are to be identified and retrieved. In at least some embodiments, the date may also include the time. The time may be any desired specificity. Consider the following example change query:
SELECT * from MY_TABLE where SPECIAL_REGISTER_DATE_CHANGE>“2018/10/01-12:20:00.000000”;
   In this example, a query is performed on a data table named MY_TABLE for data rows that were updated after 2018/10/01 at 12:20:00.000000. The time shown includes precision down to the micro second (one millionth of a second). Although this is a common level of time capture for relational databases, any time precision may be used depending on particular implementations and needs.

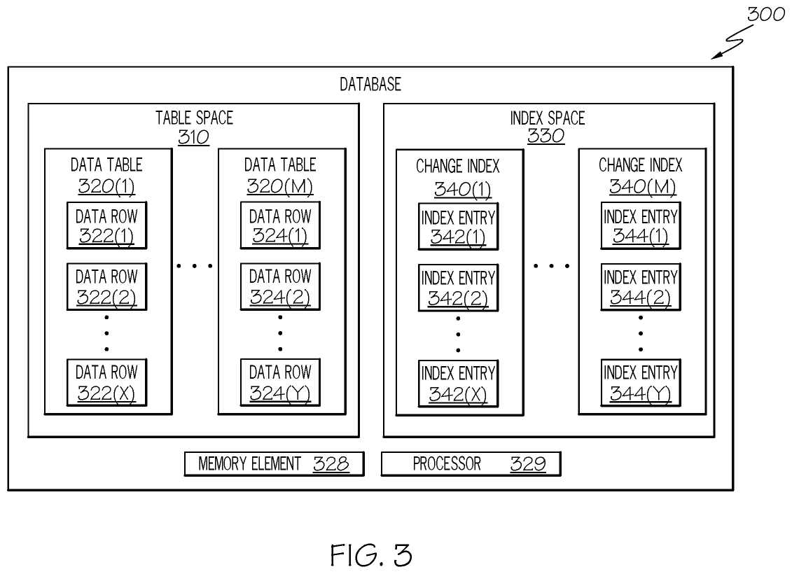

FIG. 3 is a simplified block diagram that illustrates one example of a database 300, which may be associated with embodiments described herein. Generally, database 300 illustrates a tablespace 310 with multiple data tables 320(1)-320(M) and an index space 330 with multiple change indexes 340(1)-340(M). Database 300 may also include appropriate hardware, including, but not necessarily limited to a memory 328 and a processor 329.

In database 300 each data table is associated with a change index. For example, change index 340(1) is associated with data table 320(1), change index 340(2) is associated with data table 320(2), etc. In at least one embodiment, each change index is created dynamically when selected by a user. Thus, in some scenarios where a user opts to create change indexes for fewer than all the data tables, index space 330 may be provisioned with a fewer number of change indexes than data tables in tablespace 310.

Each data table may include one or more data rows, but not necessarily the same number of data rows. Typically, each data table may include many data rows (e.g., thousands, millions, billions). For example, data table 320(1) includes data rows 322(1)-322(X) and data table 320(M) includes data rows 324(1)-324(Y).

Similarly, each change index may include one or more index entries, but not necessarily the same number of index entries. When fully populated, a change index may include as many index entries as data rows included in its associated data table. For example, when fully populated, change index 340(1), which is associated with data table 320(1), includes index entries 342(1)-342(X). Index entries 342(1)-342(X) correspond to data rows 322(1)-322(X), respectively. When fully populated, change index 340(M), which is associated with data table 320(M), includes index entries 344(1)-344(Y). Index entries 344(1)-344(Y) correspond to data rows 324(1)-324(Y), respectively. If a change index is not fully populated, then it may contain fewer index entries than data rows in its associated data table.

In at least one embodiment, an index entry in a change index may contain a unique identifier of its corresponding data row, a date (and possibly time) of the last update to the corresponding data row, and an indication of the type of update that was performed during the last update to the corresponding data row. In at least some embodiments, the date may also include a time of the update.

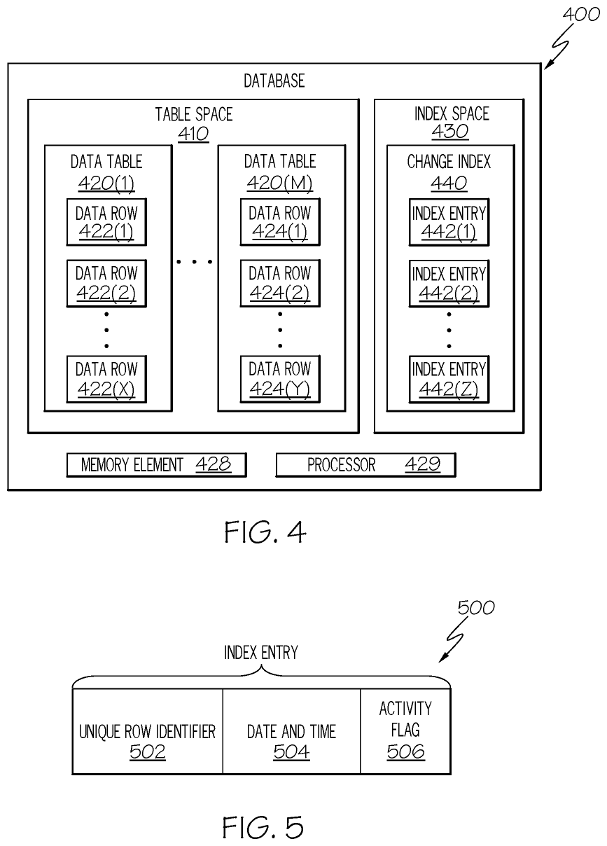

FIG. 4 is a simplified block diagram that illustrates another example of a database 400, which may be associated with embodiments described herein. Generally, database 400 illustrates a tablespace 410 with multiple data tables 420(1)-420(M) and an index space 430 with a single change index 440. Database 400 may also include appropriate hardware, including, but not necessarily limited to a memory 428 and a processor 429.

In database 400 all of the data tables in tablespace 410 are associated with a single change index. For example, change index 440 is associated with data tables 420(1)-420(M). In at least one embodiment, the change index is created dynamically when selected by a user. Thus, when change index 440 is created by the user, all of the data tables 420(1)-420(M) in tablespace 410 are associated with the change index 440.

Each data table may include one or more data rows, but not necessarily the same number of data rows. Typically, each data table may include many data rows (e.g., thousands, millions, billions). For example, data table 420(1) includes data row 422(1)-422(X) and data table 420(M) includes data rows 424(1)-424(Y).

Change index may include one or more index entries. When fully populated, change index 440 may include as many index entries as data rows included the associated data tables. For example, when fully populated, change index 440, which is associated with data tables 420(1)-420(M), includes index entries 442(1)-442(Z), where Z is the sum of all data rows in all of the associated data tables. Index entries 442(1)-442(Z) correspond respectively to data rows 422(1)-322(X), 424(1)-424(Y), and each of the other data rows in each of the other data tables. If change index 440 is not fully populated, then it may contain fewer index entries than all of the data rows in all of the associated data tables.

In at least one embodiment, an index entry in change index 440 may contain a unique identifier of its corresponding data row, a date (and possibly time) of the last update to the corresponding data row, and an indication of the type of update that was performed during the last update to the corresponding data row. In at least some embodiments, the date may also include a time of the update.

FIG. 5 illustrates a data structure format of an index entry 500 according to at least one embodiment. In at least one embodiment, index entry 500 can include a unique row identifier (URI) 502, a date and time 504, and an activity flag 506. URIs may include any identifiers that are individually unique among the URIs assigned to data rows in the same data table. In one example, URI 502 is a specific row identifier that may be created and assigned to a data row by the database management system (e.g., 141) when the data row is added to the database table. This type of URI may be maintained outside the data row as a logical to physical index, for example. A specific URI entry may be created for every stored data row. In another example, URI 502 may comprise a selection of column values that uniquely identify the row.

Date and time 504 may be derived from a timestamp generated by the processor when an update to the database is performed. Modern processors have available constructs such as special register CURRENT_DATE (for date) or CURRENT_TIMESTAMP (for date and time) that can be used to derive the date and time that a change occurred.

Activity flag 506 provides an indication of whether the last update to be performed on the data row associated with index entry 500. For example, the activity flag may indicate add, delete, or modify to provide information as to which type of update was last performed on the data row.

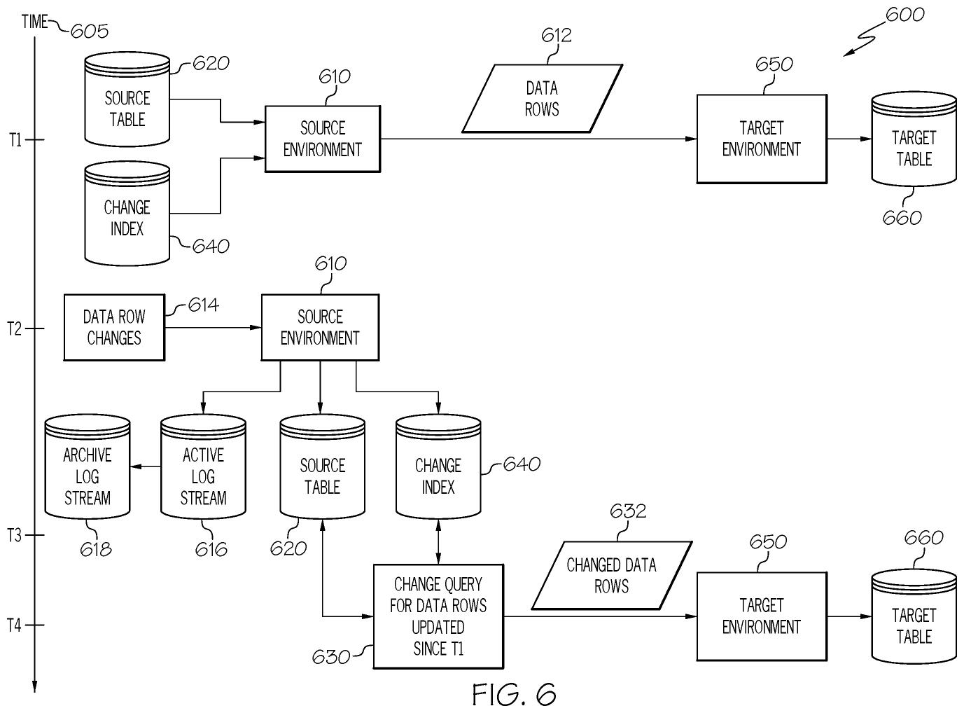

Turning to FIG. 6, a simplified block diagram illustrates an example of data and operation flow 600 of a communication system for quick identification and retrieval of changed data rows in a data table of a database according to at least one embodiment. In the data and operation flow 600, several elements are example elements of a communication system such as communication system 100. In particular, FIG. 6 shows a timeline 605 of operations and data flow in a source table 620, a source environment 610, a target environment 650, and a target table 660. The source environment 610 may also include an active log stream 616, an archive log stream 618, and a change index 640 associated with source table 620. In accordance with one or more embodiments, source table 620 is an example of a data table (e.g., 220(1)-220(M)) in a database (e.g., 120) of a communication system (e.g., 100), and change index 640 is an example of a change index (e.g., 240(1)-240(M)) that includes indexes for data rows of source table 620. Target table 660 is an example of a table in a data store (e.g., 160), in which data from source table 620 is replicated. A source environment 610 may include a database server (e.g., 140) for the source table, and target environment 650 may include a data store server (e.g., 150) for the target table. Active log stream 616 may be a log stream (e.g., 147) that is updated with source table change information by a database management system (e.g., 141). Archive log stream 618 may be an archive of active log stream 616 to hold older log stream data based on specified timing parameters.

Timeline 605 includes four times in order of occurrence, T1, T2, T3, and T4. At T1, a point in time copy could be made of all data rows 612 in source table 620 to target table 660. A change query may be used to make a point in time copy of all data rows in source table 620 to target table 660. For example, the change query could specify a date that is known to occur before the creation of source table 620 (e.g. Jan. 1, 1950). This change query will select every data row from source table 620 and provide all data rows 612 to target environment 650.

At time T2, data row changes 614 are made to source table 620. Data row changes 614 can represent any type of operations that changes data in source table 620 including, for example, user transactions and batch or utility programs that perform operations on data in source table 620. With each data row change (e.g., addition, deletion, modification) to a data row in the source table, an index entry in change index 640 corresponding to that data row is updated to include a date and time of the data row update. Each change may also be recorded in active log stream 616, and subsequently archived to archive log stream 618.

At time T3, source table 620 and target table 660 are out of sync. Target table 660 still contains the data rows from source table 620 as they appeared at time T1. At time T3, the one or more data rows in source table 620 have been updated to include data row changes 614.

At time T4, a change query 630 may be performed to retrieve data rows that have changed since time T1. The retrieved data rows can then be used to synchronize target table 660 with source table 620. Generally, the change query format may be the following:

SELECT (All data rows) from (Source Table) where (date/time field of index entry)>T1 Accordingly, each data row that was changed by data row changes 614 may be retrieved by running change query 630. The retrieved changed data rows 632 may be provided to target environment 650 to update target table 660.

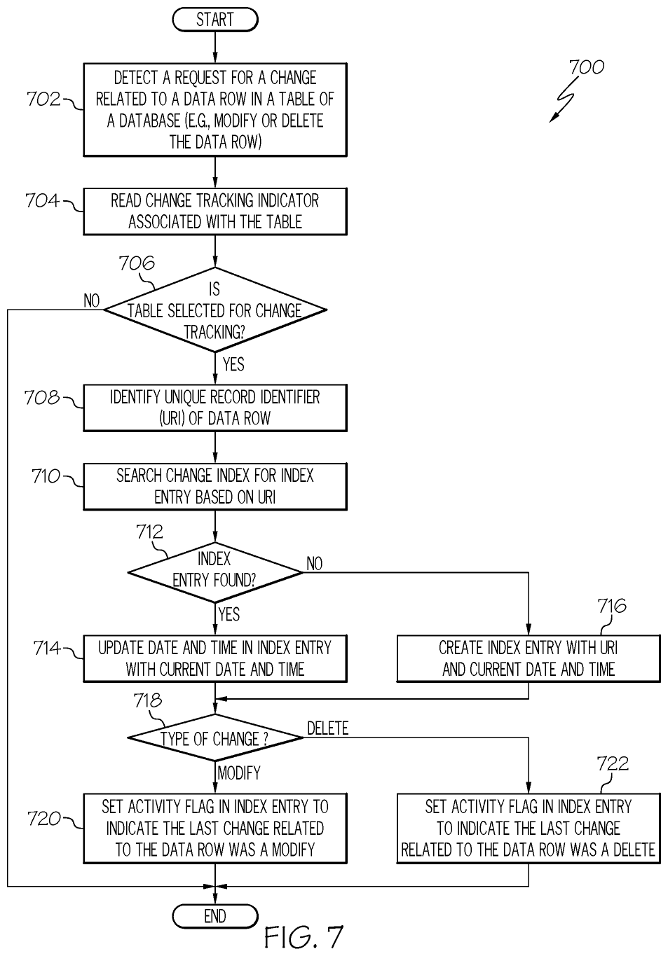

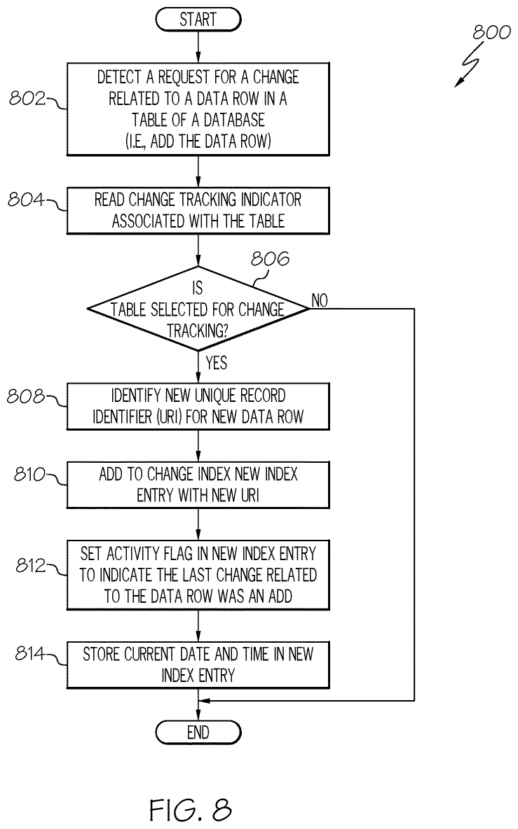

Turning to FIGS. 7-10, FIGS. 7-10 are simplified flowcharts illustrating example techniques related to one or more embodiments of a communication system, such as communication system 100, for quick identification and retrieval of changed data rows in a data table of a database (e.g., 120). In at least one embodiment, one or more sets of operations correspond to activities of FIGS. 7-10. At least some operations may be performed by a database server (e.g., 130) or a data store server (e.g., 150).

FIG. 7 is a simplified flowchart 700 illustrating an example flow that may be associated with embodiments described herein. In at least one embodiment, one or more operations correspond to activities of FIG. 7. In one example, a database server (e.g., 140), or a portion thereof, may perform at least some of the one or more operations. The database server may comprise means, such as processor 149 and memory 148, for performing the operations. In an embodiment, one or more operations of flow 700 may be performed by a change monitor (e.g., 144) that monitors changes to data rows in a data table (e.g., 220(1)-220(M)) for which a change index (e.g., 240(1)-240(M)) has been created. For ease of illustration, FIG. 7 describes an example flow of monitoring deletions of data rows and modifications to data rows in a data table. It should be apparent, however, that data row additions to the data table may be monitored in the same or different process.

At 702, a request for a change related to a data row in a data table of a database is detected. The change may be to modify the data row or to delete the data row. A request for a change may be the result of an online user transaction accessing the database, a batch job, or a utility process, in at least some scenarios.

At 704, a change tracking indicator may be read to determine whether the data table has been selected for change tracking by a change index. In at least one embodiment, a database management system may offer an authorized user the option to select one or more data tables in a data base for change tracking. If selected, a change index is created for the data table. In at least one embodiment, a change index is gradually populated with index entries as data rows in its associated data table are added, deleted, and/or modified.

At 706, a determination is made as to whether the table is selected for change tracking. If the data table is not selected for change tracking, then the flow ends because a change index is not associated with the data table.

If it is determined at 706 that the data table is selected for change tracking, then at 708, a unique record identifier (URI) of the data row is identified. In some implementations, the URI may be a selection of one or more columns in the data row that form a unique identifier for the data row. The URI may be unique within the data table or unique across multiple data tables. In other implementations, a URI may be defined by the database when data rows are added.

At 710, the index entries in the change index associated with the data table are searched based on the URI. At 712, a determination is made as to whether an index entry with the URI used in the search is found.

If an index entry is not found, then at 716, an index entry is created in the change index and is updated with the URI and the current data and time. It should be noted that requests to modify and delete data rows may occur when the change index has not been fully populated. For example, upon creating a change index for a data table, the change requests may initially include changes to data rows that are not represented by an index entry in the change index. In this scenario, an index entry may be created for the data row at 716, even if the detected request was to delete the data row.

At 718, a determination is made as to whether the type of change is a modification or deletion. If the request is to modify a data row, then at 720, an activity flag is updated in the index entry to indicate that the detected request was a request to modify the data row. If the request is to delete a data row, then at 722, an activity flag is updated in the index entry to indicate that the detected request was a request to delete the data row. Upon updating (and possibly creating at 716) an index entry corresponding to the data row identified in the change request, the flow may end.

FIG. 8 is a simplified flowchart 800 illustrating an example flow that may be associated with embodiments described herein. In at least one embodiment, one or more operations correspond to activities of FIG. 8. In one example, a database server (e.g., 140), or a portion thereof, may perform at least some of the one or more operations. The database server may comprise means, such as processor 149 and memory 148, for performing the operations. In an embodiment, one or more operations of flow 800 may be performed by a change monitor (e.g., 144) that monitors changes to data rows in a data table (e.g., 220(1)-220(M)) for which a change index (e.g., 240(1)-240(M)) has been created. For ease of illustration, FIG. 8 describes an example flow of monitoring data row additions in a data table. It should be apparent, however, that data row modifications and deletions may be monitored in the same or different process.

At 802, a request for a change related to a data row in a data table of a database is detected. The change may be to add the data row to the data table. A request to add a data row may be the result of an online user transaction accessing the database, a batch job, or a utility process, in at least some scenarios.

At 804, a change tracking indicator may be read to determine whether the data table has been selected for change tracking by a change index. In at least one embodiment, a database management system may offer an authorized user the option to select one or more data tables in a data base for change tracking. If selected, a change index is created for the data table. In at least one embodiment, a change index is gradually populated with index entries as data rows in its associated data table are added, deleted, and/or modified.

At 806, a determination is made as to whether the table is selected for change tracking. If the data table is not selected for change tracking, then the flow ends because a change index is not associated with the data table.

If it is determined at 806 that the data table is selected for change tracking, then at 808, a unique record identifier (URI) of the data row is identified. In some implementations, the URI may be a selection of one or columns in the data row that form a unique identifier for this specific data row in the data table. In other implementations, a URI may be defined by the database when data rows are added.

At 810, an index entry is created in the change index and is updated with the identified URI. At 812, an activity flag is updated in the new index entry to indicate that the detected request was a request to add the data row. At 814, the new index entry is updated with the current date and time indicating the time and date of the most recent change to the data row.

The flow may end once the index entry has been updated with the URI, the activity flag, and the current date and time.

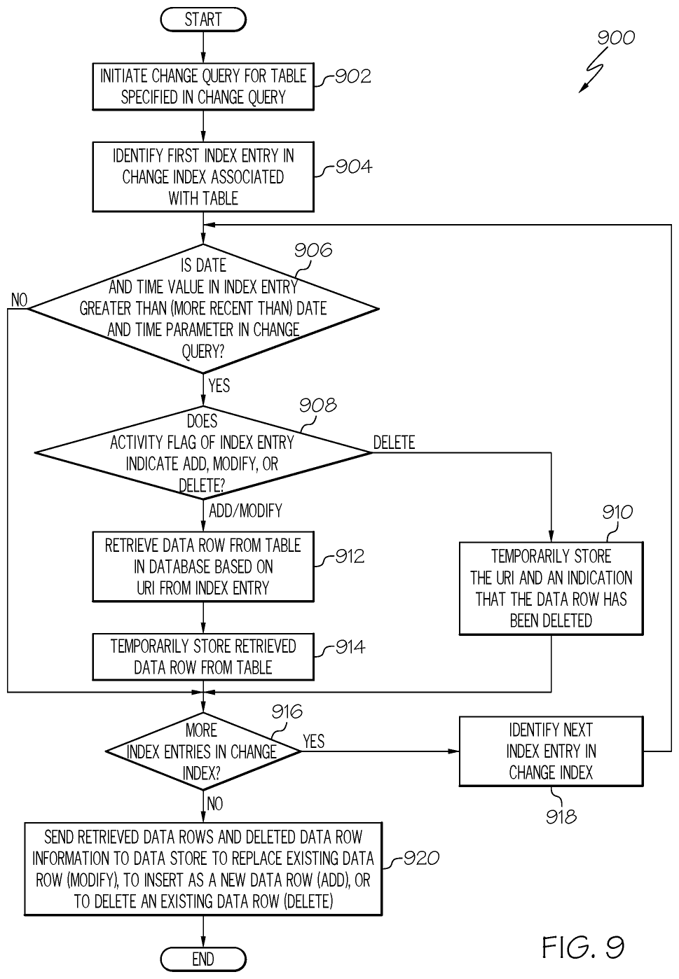

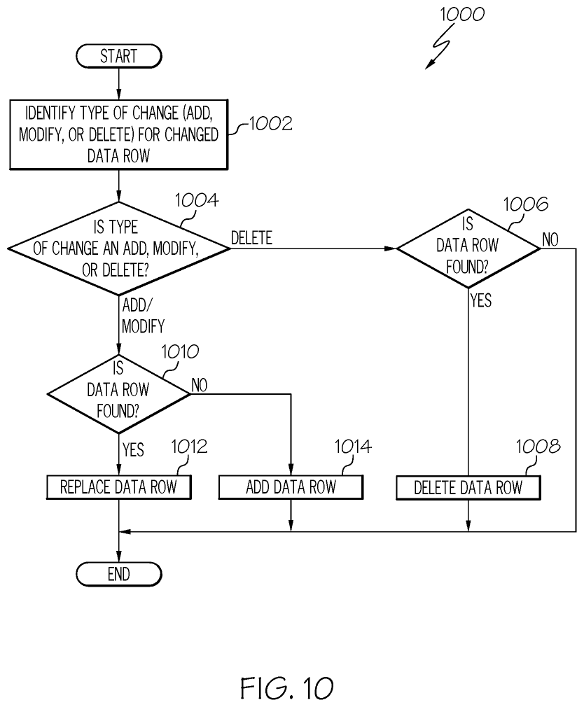

FIG. 9 is a simplified flowchart 900 illustrating an example flow that may be associated with embodiments described herein. In at least one embodiment, one or more operations correspond to activities of FIG. 9. In one example, a database server (e.g., 140), or a portion thereof, may perform at least some of the one or more operations. The database server may comprise means, such as processor 149 and memory 148, for performing the operations. In an embodiment, one or more operations of flow 900 may be performed by a change query (e.g., 146) that identifies and retrieves data rows in a data table (e.g., 220(1)-220(M)) that has been selected for change tracking and for which a change index (e.g., 240(1)-240(M)) has been created.

At 902, a change query for a data table is initiated. The change query can include parameters that specify a data table and a date and time. The date and time indicate the point in time from which data row changes that have later dates and times in the specified data table are to be identified and retrieved.

At 904, a first index entry in a change index associated with the data table is identified. At 906, a comparison is made between a date and time value in the identified index entry and the date and time parameter in the change query. If the date and time value in the index entry is not greater than (i.e., the same as or older than) the data and time parameter in the change query, then the index entry is ignored. At 916, a determination is made as to whether one or more index entries in the change index have not been evaluated. If one or more index entries have not yet been evaluated, then at 918, a next index entry in the change index is identified, and flow returns to 906 to make the date and time comparison between the change query and the newly identified index entry. Flow may continue until all of the index entries have been processed.

If at 906, the date and time value in the index entry is greater than the time parameter in the change query, then at 908, a determination is made as whether the activity flag indicates an add operation, a modify operation, or a delete operation. The activity flag indicates the operation that was performed on the data row corresponding to the index entry at the date and time stored in the index entry.

If the activity flag of the identified index entry indicates that the last operation performed on the data row was an add operation or a modify operation, then at 912, the data row corresponding to the identified index entry based on the unique record identifier stored in the index entry, may be retrieved from the data table in the database.

At 914, the retrieved data row may be temporarily stored (e.g., in cache) until all of the changed data rows identified in the query and appropriate changed data row information has been retrieved and temporarily stored. In other scenarios, the retrieved data row may be sent to a data moving facility, which facilitates moving the retrieved data rows to the target environment (e.g., data store server 150), or may be sent directly to a target environment or target repository (e.g., data store 160).

If the activity flag of the identified index entry indicates that the last operation performed on the data row was a delete operation, then at 910, the unique record identifier from the index entry and an indication (e.g., a delete flag) that the data row has been deleted may be temporarily stored (e.g., in cache) until all of the changed data row information obtained from the change query has been retrieved and temporarily stored.

Once the changed data row information has been retrieved and temporarily stored, at 916, a determination is made as to whether one or more index entries in the change index have not been evaluated. If one or more index entries have not yet been evaluated, then at 918, a next index entry in the change index is identified, and flow returns to 906 to make the date and time comparison between the change query and the newly identified index entry. Flow may continue until all of the index entries have been processed.

After all of the index entries have been processed as determined at 916, then at 920, the changed data row information that has been temporarily stored may be sent to a target table in a target environment (e.g., data store 160) or to a data moving facility that facilitates sending the changed data row information to the target table in the target environment. The changed data row information may include retrieved data rows that were added to the data table after the date and time indicated in the date and time parameter in the change query. The changed data information may include retrieved data rows that were modified in the data table after the date and time indicated in the data and time parameter of the change query. The changed data information may include identification of data rows that were deleted after the date and time indicated in the date and time parameter of the change query.

In some cases, a data row may be added and subsequently modified after data is moved (e.g., changed data rows 632) to a target environment (e.g., data store 160), but before the next change query is performed to update the target environment. Similarly, a data row in the source table may be added, modified and then deleted between the data movements. The process at the target environment (e.g., data store 160) would need to understand this possibility and include logic to handle these conditions. If a data row found in changed data rows 632 is a modify and that data row does not exist in the data store, then the data row is added to the data store. If the data row found in the changed data rows 632 is a delete and the data row does not exist in the data store 160, then the changed data row is ignored as it is no longer valid.

In at least some embodiments, the target data store (e.g., data store 160) can include unique record identifiers (e.g., assigned by database system when data row is added to database) with the stored rows. These URIs of the added, modified, and deleted data rows may be used to locate and replace data rows that were modified after the date and time in the change query, to locate and delete data rows that were deleted after the date and time in the change query, and to add data rows that were added after the date and time in the change query. If the target database system does not store URIs, then a set of columns that form a unique combination can be used as a URI to locate and change the data row in the data store 160. In some embodiments, a the data store server may use the content of the full data row to locate and change data rows in the date store 160

It should be noted that, in at least some implementations, sending the changed data row information to a target table in a target environment may be a separate function that is not included in the change query. It should also be noted that the changed data row information could be used for any desired purposed including, but not necessarily limited to, running a report on the changed data rows, searching for particular changes that occurred after the date and time specified in the date and time parameter of the change query, etc.

For ease of illustration, FIG. 9 describes an example flow of identifying and retrieving data rows based on a date and time parameter. It should be understood, however, that the identifying and retrieving operations could be performed separately. For example, a query process could identify all of the changed data rows since the specified time parameter and the URIs could be extracted or marked in suitable way. Another query could retrieve the data rows based on the identified or marked URIs.

FIG. 10 is a simplified flowchart 1000 illustrating an example flow that may be associated with embodiments described herein. In at least one embodiment, one or more operations correspond to activities of FIG. 10. In one example, a data store server (e.g., 150), or a portion thereof, may perform at least some of the one or more operations. The data store server may comprise means, such as processor 159 and memory 158, for performing the operations. In an embodiment, one or more operations of flow 1000 may be performed by an update agent (e.g., 152) for processing changed data rows received from a source environment (e.g., database server 140) that are to be applied to a target database (e.g., data store 160) to synchronize the source database (e.g., database 120) and the target database.

In at least one embodiment, flowchart 1000 illustrates change logic that may be applied to each changed data row that is received from a source environment based on a current change query that is run in the source environment. The current change query extracts changes made to data rows in a source database after a previous point in time but before the current change query is run. When the previous point in time is the last time the change query was run, then the updates to the target database by the changed data rows involves the least number of updates needed to synchronize the source and target databases.

At 1002, a determination is made as to whether the type of change to be made in the target database by a changed data row is an add, modify, or delete change. If the changed data row is a delete change, then at 1006, the data store is searched for an existing row that is to be deleted. The search can be based on a unique record identifier of the changed data row. If an existing data row is found, then at 1008, the existing data row is deleted from the data store. However, if an existing data row is not found, then the changed data row is ignored. This could occur in a scenario where the data row is first added and then deleted in the source database after the last change query but before the current change query.

If the changed data row is an add or modify change, as determined at 1004, then at 1010, the data store is searched for an existing data row corresponding to the changed data row. The search can be based on a unique record identifier of the changed data row. If an existing data row is found, then at 1012, the existing data row is replaced with the changed data row. If the changed data row is an add change, this scenario might occur if the data row is first deleted and then added in the source database after the last change query but before the current change query.

If an existing data row is not found in the data store as determined at 1010, then at 1014, the changed data row is added to the data store. If the changed data row is a modify change, this scenario could occur if the data row is first added and then modified in the database after the last change query but before the current change query.

In at least one embodiment, the operations of FIG. 10 may be performed for each changed data row (e.g., changed data rows 632) received from the source environment (e.g., database server 140).

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed sequentially, substantially concurrently, or in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that all variations of the terms “comprise,” “include,” and “contain,” when used in this specification, specify the presence of stated features, integers, steps, operations, elements, and/or components, but do not preclude the presence or addition of one or more other features, integers, steps, operations, elements, components, and/or groups thereof.

As used herein, unless expressly stated to the contrary, use of the phrase ‘at least one of’ and ‘one or more of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, references in the specification to “one embodiment,” “an embodiment,” “some embodiments,” etc., indicate that the embodiment(s) described may include a particular feature, structure, or characteristic, but every embodiment may or may not necessarily include that particular feature, structure, or characteristic. Moreover, such phrases are not necessarily referring to the same embodiment. Additionally, unless expressly stated to the contrary, the terms ‘first’, ‘second’, ‘third’, etc., are intended to distinguish the particular noun (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
detecting a request for a change related to a first data row of a first table in a first database;
identifying a unique record identifier of the first data row;
performing a first search of a change index for an index entry corresponding to the first data row, the first search based on the unique record identifier, wherein each index entry includes a date and time indicating a last change related to a corresponding data row;
updating the index entry corresponding to the first data row with a first date and time indicating the change related to the first data row; and
identifying data rows that are changed subsequent to a prior date and time by performing a second search of the change index for index entries containing a date and time that is greater than the prior date and time.

2. The method of claim 1, wherein the first data row is identified in the second search based on a determination that the first date and time is greater than the prior date and time.

3. The method of claim 1, wherein the request for the change related to the first data row is a request to modify the first data row or a request to delete the first data row.

4. The method of claim 1, further comprising:
updating an activity field in the index entry corresponding to the first data row to indicate a type of change that is made in response to the request.

5. The method of claim 1, further comprising:
obtaining, from the first table, one or more data rows of the data rows identified from the second search of the change index, wherein each of the one or more data rows is modified or added in the first table subsequent to the prior date and time; and
sending the one or more data rows obtained from the first table to a second database to replace one or more data rows in a second table of the second database.

6. The method of claim 1, wherein the identifying the data rows that are changed subsequent to the prior date and time includes identifying one or more data rows deleted from the first table subsequent to the prior date and time, the method further comprising:
sending one or more unique record identifiers corresponding to the one or more data rows deleted from the first table to a second database to cause one or more data rows in the second database to be deleted.

7. The method of claim 1, wherein the first search is performed in response to determining that the request for the change related to the first data row is a request to delete the first data row or a request to modify the first data row.

8. The method claim 1, wherein one or more other change indexes correspond to one or more other tables in the first database.

9. The method of claim 1, wherein, prior to updating the index entry corresponding to the first data row, the index entry includes the unique record identifier of the first data row, a date and time indicating a last change related to the first data row, and an activity flag indicating a type of the last change related to the first data row.

10. The method of claim 1, further comprising:
reading a change tracking indicator associated with the first table to determine whether to update index entries in the change index.

11. The method of claim 1, wherein the first database is stored in a mainframe system.

12. A non-transitory computer readable medium comprising program code that is executable by a computer system to perform operations comprising:
detecting a request for adding a first data row to a first table in a first database;
identifying a unique record identifier associated with the first data row;
updating a change index to include a new index entry corresponding to the first data row, the new index entry comprising the unique record identifier associated with the first data row and a first date and time indicating the adding of the first data row to the first table; and
identifying data rows of the first table that are changed subsequent to a prior date and time by performing a search of the change index for index entries containing a date and time that is greater than the prior date and time.

13. The non-transitory computer readable medium of claim 12, wherein the program code is executable by the computer system to perform further operations comprising:
updating an activity field in the new index entry corresponding to the first data row to indicate a last change related to the first data row was adding the first data row to the first table.

14. The non-transitory computer readable medium of claim 12, wherein the program code is executable by the computer system to perform further operations comprising:
obtaining, from the first table, one or more data rows of the data rows identified from the search of the change index, wherein each of the one or more data rows is modified or added subsequent to the prior date and time; and
sending the one or more data rows obtained from the first table to a second database to replace one or more data rows in a second table of the second database.

15. The non-transitory computer readable medium of claim 14, wherein obtaining the one or more data rows includes obtaining a second data row from the first table, wherein obtaining the second data row includes:
determining that an activity field in a second index entry found during the search of the change index indicates the second data row was modified or added in a last change related to the second data row;
using a unique record identifier in the second index entry to request the second data row from the first table; and
receiving the second data row from the first table.

16. The non-transitory computer readable medium of claim 14, wherein the first database is stored in a mainframe system, and wherein the second database is stored in a remote system accessible from the mainframe system via a network connection.

17. A system comprising:
a processor; and
a change monitor including instructions that are executable by the processor to:
detect a request for a change related to a first data row of a first table in a first database;
identify a unique record identifier of the first data row;
perform a first search of a change index for an index entry corresponding to the first data row, the first search based on the unique record identifier; and
update the index entry corresponding to the first data row with a first date and time indicating the change related to the first data row; and
a search engine to:
obtain one or more data rows of the first table that are modified or added subsequent to a prior date and time, wherein obtaining the one or more data rows is to include identifying the one or more data rows by performing a second search of the change index for index entries containing a date and time that is greater than the prior date and time.

18. The system of claim 17, wherein the system is a mainframe system.

19. The system of claim 17, wherein further instructions are executable by the processor to:
send the one or more data rows obtained from the first table to a second database to replace one or more data rows in a second table of the second database.

20. The system of claim 17, wherein the first search is performed in response to determining that the request for the change related to the first data row is a request to delete the first data row or a request to modify the first data row.
